(19) United States
(12) Patent Application Publication
(10) Pub. No.: US 2004/0262284 A1
(43) Pub. Date: Dec. 30, 2004

(54) Cooking device with high-speed heating unit

(75) Inventors: Walter Gramlich, Bruchsal (DE); Bernhard Gotz, Zaisenhausen (DE); Werner Kruger, Eppingen (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/828,674

(22) Filed: Apr. 21, 2004

(30) Foreign Application Priority Data
Oct. 22, 2001 (DE) 10151937.0
Oct. 16, 2002 (WO) PCT/EP02/11591

(51) Int. Cl. F27B 5/14; F27D 11/00

(52) U.S. Cl. 219/390

(57) ABSTRACT

A cooking device containing a muffle delimiting a cooking chamber including a hot-air heating unit, a high-speed heating unit and a control unit for regulating a high-speed heating mode. The high-speed heating unit having at least one upper heating unit. The control unit switches on the upper heating unit while simultaneously adjusting the high-speed cooking mode exclusively when operating with the hot-air heating unit.

The invention relates to a cooking device with a high-speed heating unit according to the preamble of claim 1.

U.S. Pat. No. 5,432,321 discloses a generic cooking device with an upper heating unit, a lower heating unit, a hot-air heating unit as well as a high-speed heating unit for regulating a high-speed heating mode. In basic operation with activated upper heating unit and activated lower heating unit the high-speed heating unit can be activated by an actuation switch and the hot-air heating unit for regulating the high-speed heating mode can be activated by a control.

The object of the invention is to provide a generic device, in which advantageously enabling rapid heating while avoiding wherever possible undesirable burning of remains of food during said high-speed heating mode. This task is solved according to the present invention by the features of claim 1, while advantageous configurations and further developments of the invention can be inferred from the independent claims.

The invention is based on a cooking device with a muffle delimiting a cooking chamber, at least an upper heating unit, a hot-air heating unit and a high-speed heating unit for regulating a high-speed heating mode and with a control unit.

It is put forward that the control unit exclusively regulates the high-speed heating mode in association with the hot air heating unit and activates the upper heating unit. The situation can be prevented where the lower heating unit is activated during the high-speed heating mode and where food remains, found as a rule in the lower reaches of the muffle, burn on due to an activated lower heating unit and the activated hot-air heating unit during the high-speed heating mode. Furthermore, the upper heating units are often arranged inside a muffle of the cooking device, so that the heat on the upper heating unit is advantageously removed via the hot-air heating unit and can be distributed in the cooking chamber, resulting in high efficiency and rapid heating. In addition, simple, cost-effective control can be achieved; in particular a simple and cost-effective relay without change-over contact can be used for the high-speed heating unit. The solution according to the present invention can be utilised both in cooking devices with electromechanical baking oven control and also in cooking devices with electronic baking oven control.

The upper heating unit can basically be formed by an upper heating unit and/or by a grill heating unit, whereby high efficiency can be realised with an upper heating unit with a relatively low energy requirement and cost-effective electric fuse protection, and particularly rapid heating can be realised with a grill heating unit.

If the control unit exclusively sets the high-speed heating mode in a heating phase, unnecessary loss of energy can be avoided and operating errors can be prevented.

The high-speed heating unit can be designed to be controlled automatically and/or manually by a switch. A particularly high level of comfort can be achieved with automatic control, and particularly individually adaptable actuation can be achieved with manual control.

It is further proposed that a baking oven regulator of the control unit switches off the upper heating unit switched in high-speed heating mode, whenever a set temperature is reached, enabling additional control and/or regulating components to be avoided.

If the control unit with the upper heating unit switched in high-speed heating mode activates at least one signal element, another unit can be controlled by the signal put out by the signal element, and in particular a user can be shown that the cooking device is currently in high-speed heating mode.

Further advantages will emerge from the following description of the diagrams, illustrating an embodiment of the invention. The diagram, the description and the claims contain numerous characteristics in combination. The specialist will consider the characteristics appropriately individually and combine them into additional meaningful combinations.

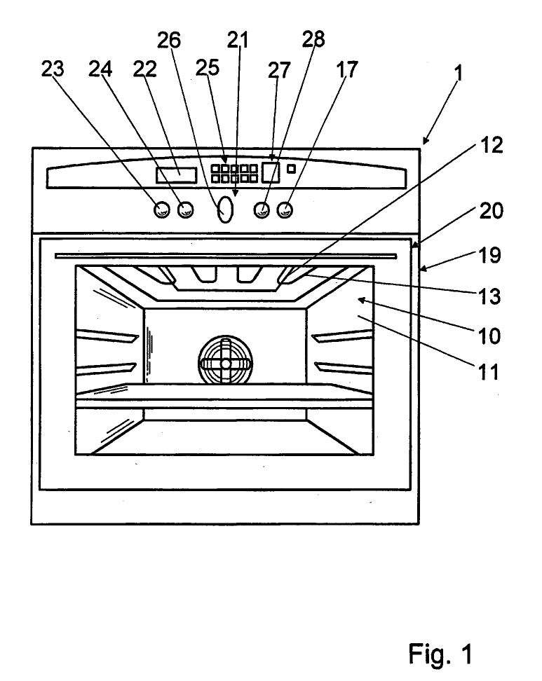

FIG. 1 shows a baking oven from the front, and

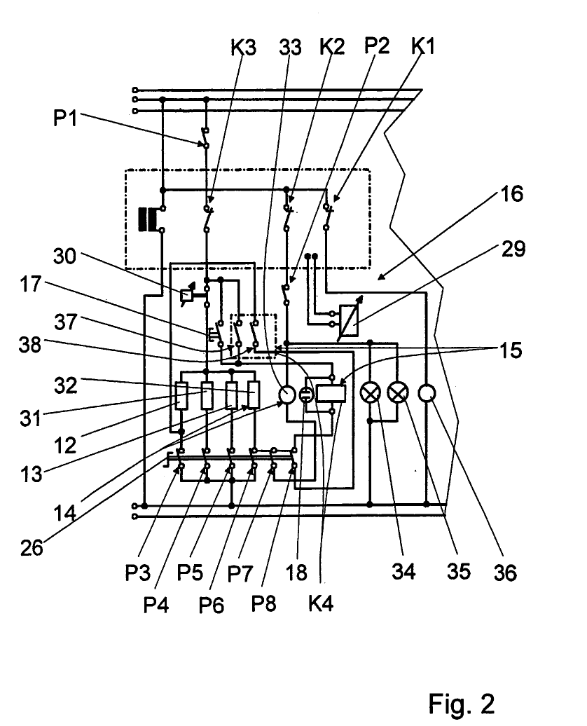

FIG. 2 is an external section of a circuit plan of the baking oven from FIG. 1.

FIG. 1 shows a baking oven 1 from the front with a muffle 11 arranged in a baking oven housing 19, which delimits a cooking chamber 10, closed with a baking oven door 20. Arranged above the muffle 11 is a control panel 21 of the baking oven 1. The control panel 21 has five actuation elements stored in a housing arranged under a panel, and two actuation keys 23, 24 for actuating a time circuit arranged under a time display 22, a retractable knob 26 for selecting an operating mode arranged centrally, under a display 25 of operating modes, and a retractable knob 28 for selecting an operating temperature arranged under a temperature display 27, as well as an actuation key 17 arranged near the retractable knob 28 for activating a high-speed heating unit 15 or for regulating a high-speed heating mode (FIGS. 1 and 2).

The baking oven 1 has a control unit 16, and with eight switch contacts P1 to P8 assigned to the knob 26, a relay K1 for a cooling fan with a cooling fan motor 36, a relay K2 for baking oven lamps 34, 35 and for a hot-air or circulating air motor 33, a baking oven cycle relay K3 and a relay K4 of the high-speed heating unit 15. The relay K4 can be switched by the actuation key 17 and has a holding contact 37 as well as a power contact 38. The control unit 16 also has a baking oven regulator 29, which cooperates with a temperature limiter 30.

The baking oven 1 also has an upper heating unit 12 arranged inside the muffle 11 with a thermal rating of 1100 W, a lower heating unit 31 with a thermal rating of 1100 W, a grill heating unit 13 with a thermal rating of 1600 W, a hot-air heating unit 14 having an annular heating element 32 with a thermal rating of 2400 W and a circulating air motor 33, which can be switched by the control unit 16 (FIG. 2). The basic operating mode of the baking oven 1 is to operate with the hot-air heating unit 14.

According to the present invention the high-speed heating unit 15 can be activated by the actuation key 17 exclusively operating with the hot-air heating unit 14, that is, in basic operating mode or in an operating mode for baking bread, wherein the hot-air heating unit 14 is operated at high power, as well as be adjusted exclusively during a heating phase and a high-speed heating mode. In the process, the upper heating unit 12 is switched on by the relay K4 of the high-speed heating unit 15, resulting in a cumulative thermal rating of 3500 W in high-speed heating mode. Further to this, a signal light 18 arranged under the actuation key 17 is activated, which illuminates the actuation key and shows a user the set high-speed heating mode. The control unit 16 could also be laid fundamentally out such that the grill heating unit 13 is activated alone or selectively with the upper heating unit 12 in high-speed heating mode.

When a set temperature is reached, the high-speed heating unit 15 or the upper heating unit 12 switched in high-speed heating mode is switched off by the baking oven regulator 29 of the control unit 16. If the set baking oven temperature on the knob 28 is increased, the high-speed heating unit 15 can be re-activated by the actuation key 17.

1-8. (canceled)

9. A cooking device, comprising:
a muffle delimiting a cooking chamber;
at least an upper heating unit;
a hot-air heating unit;
a high-speed heating unit for regulating a high-speed heating mode; and
a control unit which adjusts said high-speed heating mode exclusively when operating with said hot-air heating unit and at the same time switches on said upper heating unit.

10. The cooking device according to claim 9, including said high-speed heating unit switched on in said high-speed heating mode is said upper heating unit.

11. The cooking device according to claim 10, including said upper heating unit is arranged inside of said cooking chamber.

12. The cooking device according to claim 10, including said upper heating unit is formed by a grill heating unit.

13. The cooking device according to claim 9, including said control unit adjusts said high-speed heating mode exclusively in a heating phase.

14. The cooking device according to claim 9, including said high-speed heating unit includes a manual control switch for manually controlling said high-speed heating unit.

15. The cooking device according to claim 10, including a baking oven regulator in said control unit, which switches off said upper heating unit when a preset temperature is reached in said cooking chamber.

16. The cooking device according to claim 10, including said control unit having a signal element and said control unit activates said signal element when said upper heating unit is switched on in said high-speed heating mode.
